(19) United States
(12) Patent Application Publication
(10) Pub. No.: US 2023/0345205 A1
(43) Pub. Date: Oct. 26, 2023

(54) HOME LOCATION BASED NORMALIZATION

(71) Applicant: Orbital Insight, Inc., Palo Alto, CA (US)

(72) Inventors: Scott M. Adams, Palo Alto, CA (US); Steven J. Bickerton, Redwood City, CA (US); Christian D. Clanton, Palo Alto, CA (US); Fergal R. Mullally, Palo Alto, CA (US)

(21) Appl. No.: 17/725,905

(22) Filed: Apr. 21, 2022

(51) Int. Cl. H04W 4/029; H04W 4/021; H04W 48/16

(52) U.S. Cl. CPC H04W 4/029; H04W 4/021; H04W 48/16

(57) ABSTRACT

A device receives an AOI selection that indicates a geographic area. The device accesses AOI device location data for the AOI that indicates locations of plural devices detected within the AOI. The device sets a device penetration rate configuration based on at least one characteristic of the AOI. The device determines respective weighting factors for each of the plural devices detected within the AOI based on one or more device penetration rates corresponding to the set device penetration rate configuration. Each of the one or more device penetration rates indicating, for a corresponding geographic region, a number of devices with home locations within the geographic region divided by a population of the geographic region. The device generates an estimate of a number of users in the AOI based on the plural devices detected within the AOI, and the respective weighting factors. The device transmits the estimate to a client device.

### TECHNICAL FIELD

This disclosure relates generally to processing of sensor data, and, in particular, to geospatial analytics based on device location data.

### BACKGROUND

Estimating foot traffic (e.g., a prediction of a number of users) at an area of interest (AOI) may be valuable in many scenarios. For example, estimating foot traffic over time at a location may assist a stakeholder in determining the popularity of that location relative to other commonly owned locations or competitor locations. As another example, traffic patterns of users in a city or neighborhood may assist city planners in developing new infrastructure and in developing emergency response plans.

Multiple methods may be used to determine foot traffic at a target AOI. One method may involve counting a number of devices detected at the target AOI. However, it is difficult to translate a count of a number of devices detected at the target AOI into an accurate count of people who have visited the target AOI because not all people may carry devices, and because not all devices opt in to share their data. Even if they did, a huge amount of network bandwidth and computational expense would be required.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

FIG. 1 illustrates a network environment for interfacing client devices and device location data providers with an AOI analysis and reporting unit, in accordance with one or more embodiments.

FIG. 2 is a schematic diagram illustrating an exemplary AOI selected within a geographic area that is divided into a plurality of geographic regions, in accordance with one or more embodiments.

FIG. 3 illustrates an example of a data structure of device location data received from one or more device location data providers, in accordance with one or more embodiments.

FIG. 4 is a block diagram illustrating components of the AOI analysis and reporting unit, in accordance with one or more embodiments.

FIG. 5 is a block diagram illustrating components of an example machine able to read instructions from a machine-readable medium and execute them in a processor (or controller).

FIG. 6 is an exemplary flowchart of a process for estimating foot traffic in an AOI based on device location data.

FIG. 7 depicts an exemplary user interface for inputting an AOI selection and corresponding configuration data.

FIG. 8 depicts another exemplary user interface for receiving normalized foot traffic data as an output based on input AOI configuration data and AOI device location data.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Configuration Overview

Device location data may be obtained from one or more third party data providers (e.g., data aggregators, device location data providers), who have agreements with a network of original sources, such as application developers who have applications installed on smartphones or software development kits (SDKs) embedded in other software systems. The device location data can be collected from smartphone applications, mobile carriers, satellite providers, radio towers, and other means for smartphones. It can also be collected for additional types of devices: land vehicles (connected cars), ships (AIS data), planes (ADSB data), credit cards (Point of Sale data), wearable tech (FitBit, Oura, etc.), and, in general, any Internet of Things connected device that tracks latitude and longitude position. For all of these devices it is possible to construct a “home location” describing the likely location that the owner of said device resides, with varying levels of accuracy. However, not all persons visiting a target AOI may have a location tracking-enabled device (e.g., device, location-enabled device, and the like). Moreover, the likelihood that a person visiting the target AOI is carrying a location-enabled device that is captured by the data aggregators varies with time, geography, and demographics (among other factors). Since these dependencies are not provided by the data aggregators, it is difficult to translate the device location data provided by the data aggregators into accurate estimates of a total number of people visiting the target AOI.

To overcome the above problems, this disclosure proposes a system and method for accurately estimating foot traffic (e.g., a count of people or users) at an AOI based on a sampling of a smaller number of users (out of all users with devices at the AOI) who have opted in to share their location data, thereby saving network bandwidth, and reducing computational expense. This disclosure pertains to a system and method for accurately estimating foot traffic visiting an AOI over time based on device location data (e.g., anonymized cell phone location data, ping data). A user interface of an AOI analysis and reporting unit may enable a user to select or otherwise input an AOI indicating a geographic area on a map (e.g., by drawing boundaries of a polygon on the map, selecting an entity on the map or include from a list of geographic or other demarcated regions, and the like). The AOI analysis and reporting unit may then receive ping data (e.g., Device ID, Timestamp, Location, and the like) from one or more device location data providers for a plurality of devices. Out of the received device location data, the AOI analysis and reporting unit may identify AOI device location data indicating devices whose locations are detected within the AOI. The AOI analysis and reporting unit may perform a home location normalization operation to translate the AOI device location data indicating a count of a number of unique devices visiting the AOI (e.g., during a particular hour, day, week, month, and so on) into an accurate number of users (people) visiting the AOI.

To perform the home location normalization operation, the AOI analysis and reporting unit may determine home locations for all devices in the device location data received from the data aggregators. For example, the AOI analysis and reporting unit may determine the home location for each device based on night-time pings over a given month. The AOI analysis and reporting unit may then calculate device penetration rates based on the device home locations by dividing a geographic area corresponding to the device location data into a plurality of geographic regions and calculating a device penetration rate for each geographic region based on the number of devices with home locations in that region. The geographic area may be divided into the plurality of geographic regions at a sufficiently fine level of granularity so that regional differences in demographics of the population are preserved (e.g., first geographic regions). For use cases where high computational efficiency is required (e.g., to meet service level agreement thresholds, reduce the amount of computation required to perform the home location normalization operation, etc.) when tabulating AOI foot traffic counts, the geographic area may also be divided into geographic regions at coarser levels of granularity and device penetration rates calculated for the coarser geographic regions (or a device penetration rate calculated for the geographic area as a whole) based the device home locations in the coarser regions (or in the whole area).

For example, the AOI analysis and reporting unit may calculate a set of device penetration rates of a device penetration rate configuration where a geographic area is divided into the smallest possible geographies (e.g., census block groups; geographic regions at a finer level of granularity) for which population data is available and device penetration rates are calculated for each divided geographic region based on devices with home location in the region. To calculate the device penetration rate, the AOI analysis and reporting unit may divide the number of devices with home locations within the geography (e.g., census block group) by the population of the geography (e.g., known from official census data). The AOI analysis and reporting unit may further calculate another set of one or more (generic) device penetration rates of another device penetration rate configuration where the device penetration rate is calculated for the whole geographic area, or the area is divided into geographic regions at a coarser level of granularity for larger geographies (e.g., neighborhoods, towns, cities, states, countries, and the like; second geographic regions) for which accurate population data is available, and the device penetration rates are calculated for each divided geographic region based on devices with home location in the region.

When calculating the normalized foot traffic, the AOI analysis and reporting unit may use (or calculate), based on a set configuration, one of the sets of device penetration rates having a particular (coarser or finer) level of granularity of the geographic regions ranging from the smallest geography (e.g., area subdivided into relatively finer geographic regions) with accurate population data available to larger geographies (e.g., area subdivided into relatively coarser geographic regions, or penetration rate calculated for the undivided area) based on predetermined characteristics (e.g., type of AOI, foot traffic tabulation frequency, application type corresponding to the AOI device location data received from the data aggregators, and the like) of the target AOI.

To calculate the normalized foot traffic of the AOI, the AOI analysis and reporting unit may sum over all of the devices whose location is detected to be within the AOI, the inverse of the device penetration rate (e.g., weighting factor) of the home geographic region of the device. The AOI analysis and reporting unit is thus configured to use accurate (and more customized) device penetration rates that are based on geographic regions that are sufficiently fine or granular so that regional differences in demographics are preserved, thereby compensating for time-varying, demographic-dependent shift in the device home locations. Further, based on predetermined characteristics of the AOI, the unit is also configured to selectively use a more computationally efficient algorithm to calculate foot traffic by using (one or more; generic) device penetration rates that correspond to larger geographies (or the whole geographic area) when assigning weighting factors to the devices in the AOI, thereby reducing the amount of computation required to calculate weighting factors for each device in the AOI.

Further, when calculating the device penetration rates based on device home locations or when calculating the number of devices within the AOI, the AOI analysis and reporting unit may be configured to apply an activity filter to filter out devices from the dataset based on characteristics of the AOI being analyzed. For example, based on a determined type of the AOI (e.g., casino) the unit may identify and set a dwell time range (e.g., 2-3 hours) for the AOI, and the unit may only include devices in the AOI device location data, those devices whose ping data indicates a dwell time at the AOI that is within the set time range.

### AOI Analysis and Reporting Unit Functionality

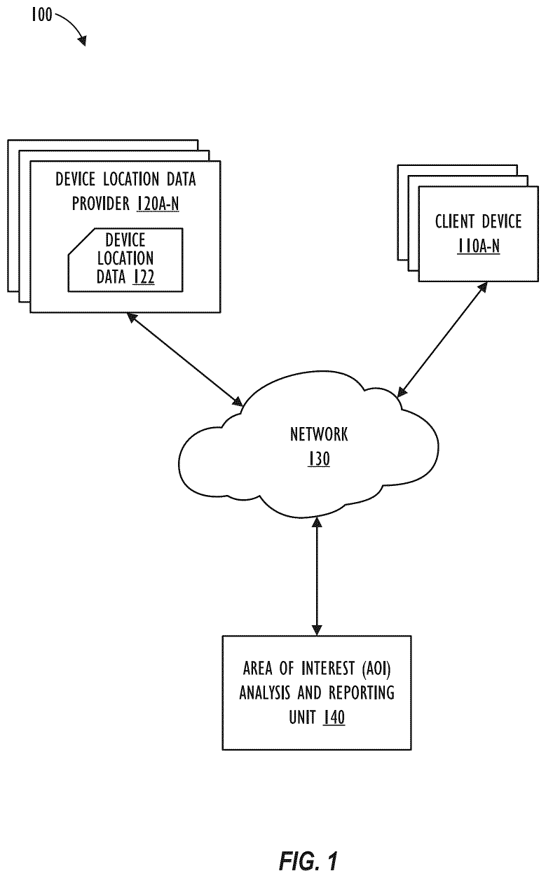

FIG. 1 illustrates network environment 100 for interfacing client devices and device location data providers with an AOI analysis and reporting unit, in accordance with one or more embodiments. FIG. 1 includes one or more client devices 110A-N (generally referred to as 110 herein), one or more device location data providers 120A-N (generally referred to as 120 herein), network 130, and AOI analysis and reporting unit 140.

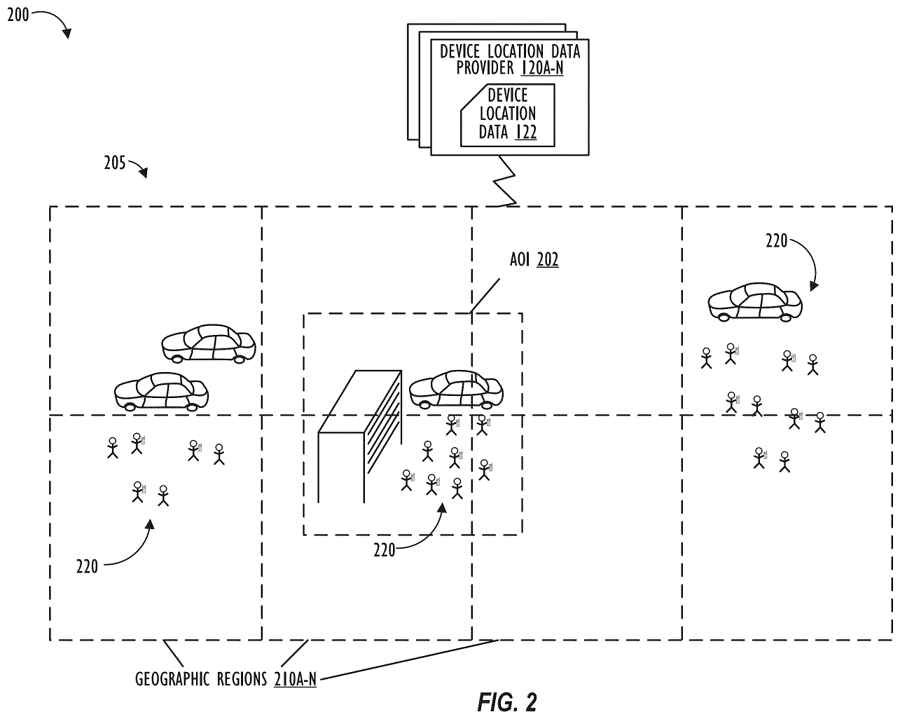

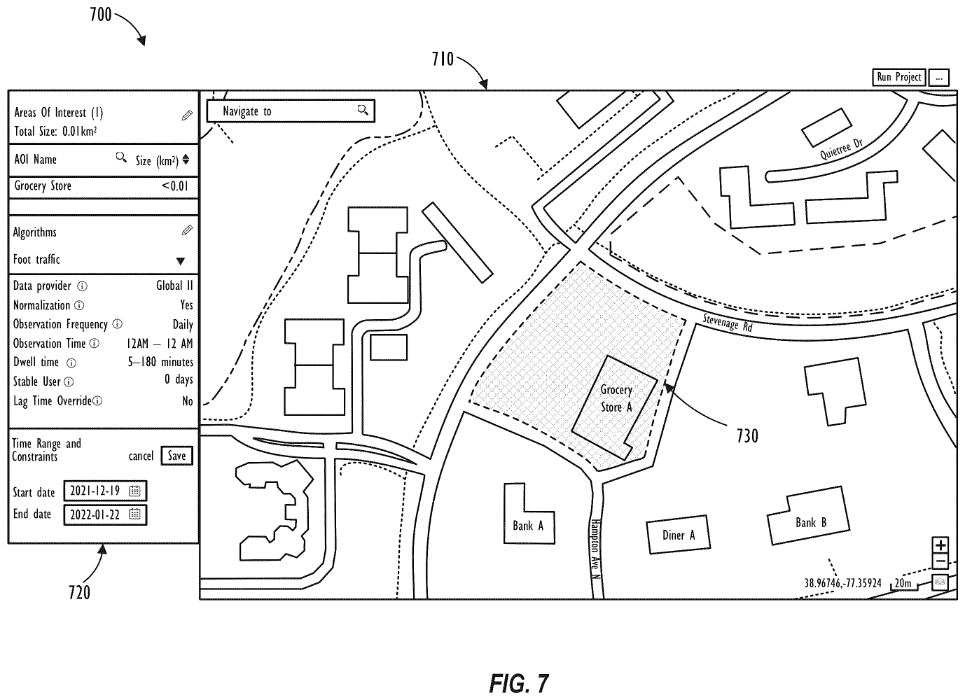

Client device 110 may be operated by any user wishing to perform normalized foot traffic analysis of an AOI based on device location data. For example, a user inputs AOI configuration data (e.g., selection location of AOI on a map, select AOI from a list, input start and end dates of observation, select type of AOI, select observation frequency, dwell time, and the like) related to an AOI project into a user interface (e.g., as discussed below with respect to FIG. 7), and those parameters are transmitted over network 130 (which may be any network, such as the Internet) to AOI analysis and reporting unit 140, which may perform the normalized foot traffic analysis of the input AOI using the systems and methods disclosed below with respect to FIGS. 2-6. In one embodiment, AOI analysis and reporting unit 140 operates partially or fully as a module of client device 110 (e.g., as a downloaded application).

The device location data providers 120 receive location data information from location-enabled devices. This information may be stored as device location data 122 and may be transmitted in whole or in part (e.g., excluding personally identifiable information) to AOI analysis and reporting unit 140.

Network 130 may be any network, such as the Internet, a wide area network, a local area network, a cellular network, or any other means of data communication through which AOI configuration data and normalized foot traffic data may transmitted between client device 110 to AOI analysis and reporting unit 140, and through which device location data 122 may be transmitted from device location data provider 120 to AOI analysis and reporting unit 140.

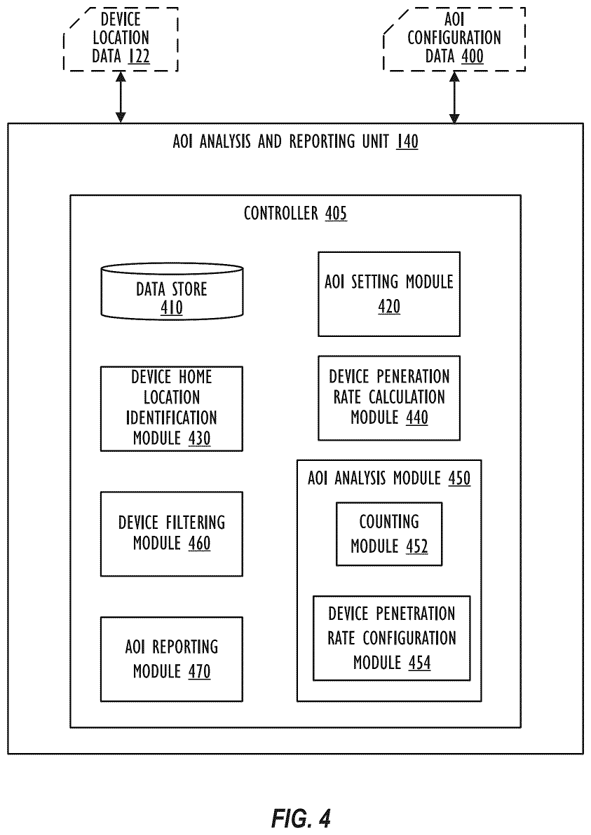

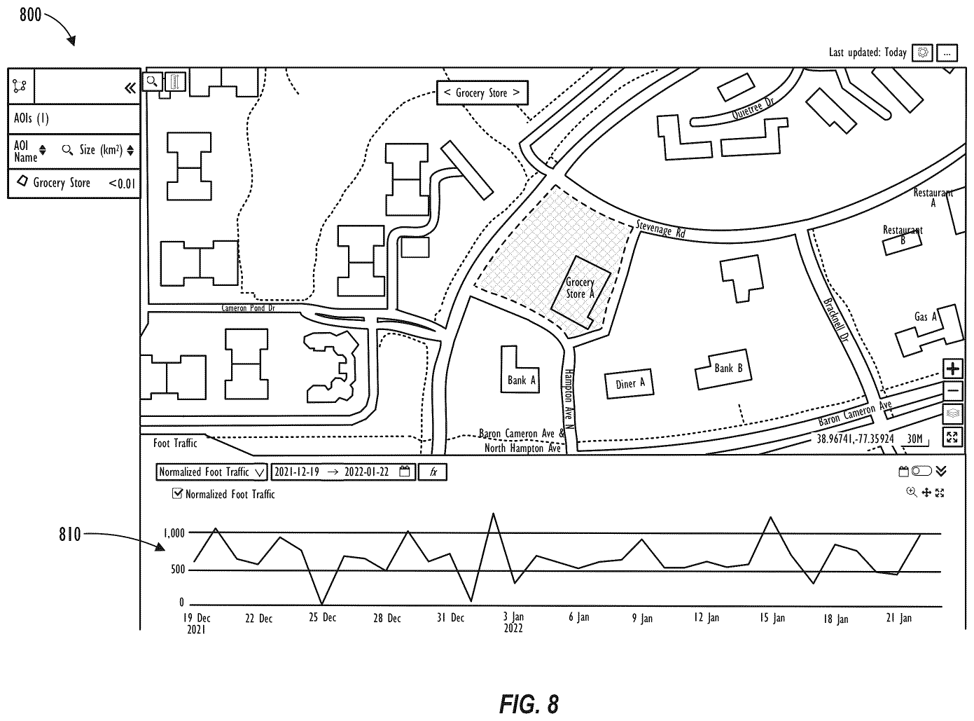

AOI analysis and reporting unit 140 is configured to perform normalized foot traffic analysis based on the AOI configuration data provided by client device 110. Specific details of the structure and features of AOI analysis and reporting unit 140 are provided below with respect to FIGS. 4-6. A result of the normalized foot traffic analysis (e.g., a daily count of a number of users visiting the AOI) may be transmitted by AOI analysis and reporting unit 140 to client device 110 (e.g., using network 130) for presentation to a user of the client device (e.g., via a user interface as discussed below with respect to FIG. 8).

FIG. 2 is a schematic diagram 200 illustrating a geographic area 205 that is divided into a plurality of geographic regions 210A-N and that includes a plurality of location-enabled devices 220, in accordance with one or more embodiments. FIG. 2 also shows an AOI 202 that corresponds to a part of the geographic area 205 and that may be input, e.g., by a user input on a user interface of a client device 110 (e.g., as discussed below with respect to FIG. 7).

The AOI 202 is an area on a land surface (e.g., the surface of the Earth), and includes all features (natural and man-made) within that area. The definition of the AOI may be provided by a user (e.g., via client device 110) or by another third-party system external to AOI analysis and reporting unit 140, e.g., via an application programming interface (API) or graphical user interface (GUI). As shown in FIG. 2, the AOI 202 may be defined by a closed boundary on the land surface. The closed boundary itself may be defined using various connected geographic markers, which may be indicated using geographic coordinates, such as longitude and latitude indicators. Alternatively, the AOI 202 may be defined by a set of vectors describing the closed boundary (e.g., drawing a polygon on a map). In some cases, the AOI 202 may be defined using multiple closed boundaries, with each closed boundary defined using one of the methods noted above. AOI 202 may also have within one of its closed boundaries an excluded area or areas. These excluded areas may also be defined using closed boundaries and specified in a similar fashion. In another embodiment, AOI 202 may be defined using cartographical indicators, i.e., commonly, conventionally, administratively, or legally agreed upon indicators of bounded areas on a land surface. For example, these cartographical indicators may include a point of interest (POI), landmark, address, campus, compound, one or more buildings or other structures, super structures, a portion of a superstructure, city block, postal code, city/town/village, metropolitan area, country, province/county, neighborhood, unincorporated area, and so on, plus or minus a tolerance area beyond (or within) the cartographical indicators, which may be defined in absolute or percentage from the cartographical indicators. For example, the AOI 202 may be indicated by drawing a polygon on a map. As another example, AOI 202 may be indicated by a user selecting an entity (e.g., building) on a map, or selecting an entity from a list. As yet another example, AOI 202 may be indicated by a user by drawing or dragging a cursor or finger over a user interface (e.g., as shown in FIG. 7) to manipulate boundaries of the AOI 202.

AOI 202 represents a geographic area for which information, such as a foot traffic estimate (a count of number of users visiting AOI 202) during a given time frame, is of interest to a requesting party. For example, an entity may be interested in the amount of foot traffic over time at a particular big-box store location to analyze consumer spending, or a municipal government may be interested in the amount of foot traffic over time at a public transit station to determine how to plan for future public transportation infrastructure developments, or an oil refinery may be interested in the amount of foot traffic over time to detect anomalies (e.g., huge influx of magnificence crew to fix a major outage). AOI 202 may be, for example, a big-box store location, a hospital, a gas station, a shopping mall, an airport, a neighborhood, a school, a university campus, a factory, an oil refinery, a warehouse, a building, a casino, and the like. AOI 202 may further be bounded by an upper elevation and/or lower elevation limit. In one embodiment, AOI 202 is not a location on the land surface, but a closed three-dimensional volume at any location, which may or may not be offset from ground level. It may be defined using a plurality of three-dimensional coordinates which are connected together using planar surfaces or may be described in terms of geometric shapes.

As shown in FIG. 2, geographic area 205 may include a plurality of location-enabled devices 220. Each location-enabled device 220 may be a device that is able to gather or identify location information of the device and transmit the location information via a network (e.g., a mobile, cellular, wireless, or other network; network 130) to an external system, such as the device location data providers 120A-N. Examples of location-enabled devices 220 include smartphones, tablets, smart watches, navigation units on vehicles, waterborne vessels, GPS trackers, laptops, etc. The location information may be gathered using a component of the device 220 capable of receiving information from GPS or similar satellite navigation system (e.g., GLONASS, Galileo, Beidou), or may be gathered using other methods of approximating location, such as via detection of nearby Wi-Fi networks or cellular network towers. Each device 220 may be associated with a user (or more than one user). It may be a device carried or worn by the user. In this respect, it may serve as a proxy for the user and provide information about the user, and in particular, the location information of the user. Therefore, by receiving data that includes location information from the device 220, the current location of an associated user may also be inferred at a point in time.

Location-enabled devices 220 may transmit device location data (e.g., ping data) including information regarding the current geographic location of device 220, and information regarding a current time (e.g., local time or universal time/GMT) to device location data provider 120. The geographic location may be indicated using geographic coordinates, e.g., latitude, longitude, and/or altitude data, nearby Wi-Fi network names, nearby cellular tower locations, or other methods, such as those used to define the AOI 202. The current time may be indicated in varying levels of accuracy, e.g., millisecond, second, minute, hour, or day level of accuracy. For example, the current time may be indicated in a 64-bit integer using the Unix time format.

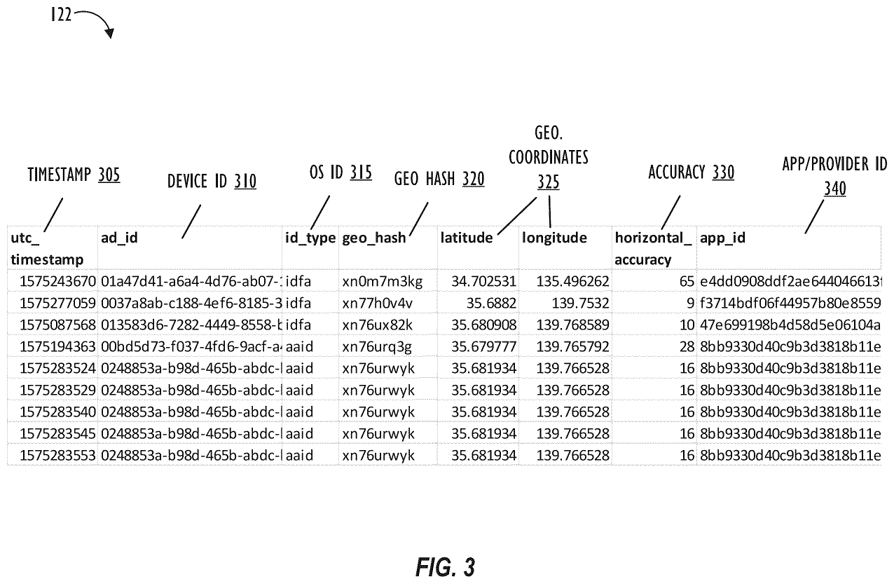

The device location data or ping data 122 transmitted by location-enabled device 220 may include additional information such as a unique device identifier, a mobile provider information, a mobile application name which gathered and transmitted the location data, historical geographic location information, operating system information, version number information, an identifier corresponding to the mobile application name which gathered and transmitted the location data, accuracy level, and so on. Information included in ping data 122 is described in further detail below in connection with FIG. 3.

Device location data providers 120 (e.g., third party data aggregators) receive the location data or ping data from location-enabled devices 220. This information may be stored as device location data 122 by data aggregators 120 and may be transmitted in whole or in part (e.g., excluding personally identifiable information) to AOI analysis and reporting unit 140. Each device location data provider 120 may be configured to gather location information from a subset of mobile devices 220 (e.g., classified based on application, device manufacturer, device operating system, or other entity which gathers location information on the device 220). For example, a first set of location-enabled devices 220 have application A installed, which transmits location information to device location data provider 120A, while a second set of location-enabled devices 220 (which may overlap with the first set) have application B installed, which transmits location information to a separate device location data provider 120B.

The application on the location-enabled device 220 may transmit the location information with a predetermined (app-specific) cadence (frequency), or based on predetermined conditions being met, or occurrence of a predetermined event. The application on the location-enabled device 220 may transmit the location information by accessing one or more APIs of an operating system of the mobile device in order to access a data transmission mode that allows the application to transmit the location information across a network, e.g., via cellular data transmission, Wi-Fi data transmission, Bluetooth data transmission, or any other network transmission technology, to device location data provider 120, and more specifically, to one or more network servers of the device location data provider 120. The application may access the device location data by using an API of an operating system of the device 220. While the provider of the application and the device location data provider 120 may be the same entity, in some cases these entities are separate, with the application provider sending the location data of the mobile devices 220 to the device location data provider 120 for collection.

FIG. 2 further shows that geographic area 205 may be divided into a plurality of geographic regions 210A-N (e.g., generally referred to hereinafter as 210). Geographic regions 210 may be any commonly, conventionally, administratively, or legally agreed upon geographic units (e.g., people blocks, population blocks) with accurate population data available. For example, each geographic region 210 may correspond to a census block group. Each census block group is made up of one or more census blocks. Census blocks are typically bounded by roads and highways, town/city/county/state boundaries, creeks and rivers, etc. In cities, census blocks may correspond to city blocks, but in rural areas where there are fewer roads, blocks may be delimited by other features such as political boundaries, rivers and other natural features, as well as parks and similar facilities, etc. The population of census blocks may vary significantly. For example, a census block in a rural area may have a reported population of zero, while a census block that is entirely occupied by an apartment complex might have several hundred inhabitants. Other examples of geographic regions 210 include census tracts, postal codes, towns/cities/villages, counties, states, countries, and the like. Geographic region 210 can be any geographic unit or block whose accurate population count is known. Thus, geographic regions 210 may be defined as non-overlapping polygons or blocks (of same or different sizes, same or different shapes) in a geographic area, so long as accurate population data for each polygon or block is known. In FIG. 2, geographic regions 210 are shown as being rectangular in shape. However, this is for ease of illustration. The number, shape, or size of geographic regions 210 is not intended to be limiting. Any number of geographic regions 210 may be defined, each with a same or different shape and size, so long as the geographic regions 210 are non-overlapping and accurate population count of each region or block is known.

Further, in FIG. 2, AOI 202 is shown as being rectangular in shape. However, this is for ease of illustration, not intended to be limiting. As may be evident from the above discussion, AOI 202 may have any shape, and may be defined using a variety of methods. The size of AOI 202 relative to the size of geographic regions 210 is also not intended to be limiting. AOI 202 may be smaller than each of the geographic regions 210. Alternately, AOI 202 may be larger than each the geographic regions 210. Or AOI 202 may be smaller than some of the geographic regions 210 and larger than other geographic regions 210. Also, AOI 202 may overlap with one or more geographic regions 210. In the example shown in FIG. 2, AOI 202 overlaps with four adjacent geographic regions 210. However, in other examples, AOI 202 may fall within a single geographic region 210, or may overlap with two, three, or five or more geographic regions 210.

FIG. 3 illustrates an example data structure of device location data 122 (e.g., location data, ping data, and the like) transmitted by location-enabled devices 220, in accordance with one or more embodiments. As explained previously, device location data 122 may be used to perform the normalized foot traffic analysis for an AOI specified by a user. As shown in FIG. 3, device location data 122 may include location data corresponding to one or more pings from one or more devices that has been transmitted by location-enabled devices 220 and received by one or more device location data providers 120. Each row (e.g., each instance, each ping, each entry, and the like) of device location data 122 includes data corresponding to a plurality of tags (e.g., labels, columns), e.g., timestamp 305, device identifier (ID) 310, operating system (OS) ID 315, geo hash 320, geographic coordinates 325, accuracy level 330, and application ID 340. In other embodiments, each row of device location data 122 may include data corresponding to additional or fewer tags.

Timestamp tag 305 indicates a timestamp at which the ping was reported by a corresponding location-enabled device 220. Data corresponding to the timestamp tag 305 may be used when determining whether a ping is within a particular time interval (e.g., observation time interval). The device ID tag 310 identifies each individual unique device. The device ID tag 310 allows AOI analysis and reporting unit 140 to determine the identity of individual devices in order to perform tasks such as filtering out devices which do not meet a dwell time requirement (e.g., a specified dwell time range), to determine revisit rates, to count the number of unique devices in a time interval, and so on. Each device ID may be a globally unique identifier (GUID). As is evident from the exemplary device location data 122 shown in FIG. 3, multiple pings may be transmitted from the same device at different points in time, thereby allowing AOI analysis and reporting unit 140 to determine the dwell time of the user associated with the device at a particular location or determine the home location of the device within a particular geographic region. The OS ID tag 315 indicates an operating system of the device 220 that reported or transmitted the device location data entry. Each operating system may be indicated using a four-letter code.

The geo hash tag 320 indicates a unique identifier for the reported location provided by the device 220. The geo hash tag 320 may indicate a geographic encoding for a specific location, represented using a string of alphanumeric characters, and may represent a set of geographic coordinates to a certain degree of accuracy. The geographic coordinates tag 325 indicate latitude and longitude coordinates which have been reported by the corresponding device 220. These are accompanied by an accuracy measure tag 330, which indicates the accuracy of the geographic coordinates in distance (e.g., 16 ft accuracy). Each ping may also include an app/provider ID tag 340. This tag may indicate the application (e.g., smartphone app) on the device 220 which collected and transmitted the location information, or a provider which provided the location information to AOI analysis and reporting unit 140. Data corresponding to this tag may also be a GUID.

Device location data 122 captured by device location data providers 120 from location-enabled devices 220 in geographic area 205 may be transmitted to AOI analysis and reporting unit 140 for performing normalized foot traffic analysis of a target AOI. FIG. 4 is a block diagram illustrating components of AOI analysis and reporting unit 140, in accordance with one or more embodiments. As shown in FIG. 4, AOI analysis and reporting unit 140 receives device location data 122 and AOI configuration data 400 to perform the normalized foot traffic analysis of the AOI based on device location data. AOI configuration data 400 may include AOI selection data indicating the AOI that is to be subject to analysis, and related configuration data. For example, a user of a client device (e.g., 110 in FIG. 1) may create a new AOI project by performing operations on a user interface to select an area on a map and specify the AOI (e.g., as described later in connection with FIG. 7), and input configuration data such as start date and end date, dwell time range, observation time range, observation frequency, and the like. As will be described later, some of the configuration data may be automatically generated by AOI analysis and reporting unit 140.

AOI unit 140 may include a controller 405 which may in turn include various components. The components may include, e.g., one or more processors, data store 410, AOI setting module 420, device home location identification module 430, device penetration rate calculation module 440, AOI analysis module 450, device filtering module 460, and AOI reporting module 470. Some embodiments of controller 405 have different components than those described here. Similarly, in some cases, functions can be distributed among the components in a different manner than is described here. AOI analysis module 450 may in turn include counting module 452 and device penetration rate configuration module 454.

Data store 410 stores data received by AOI unit 140. Data store 410 also stores data that may be used by AOI unit 140 to provide functionality attributed to the various components thereof. That is, data store 410 (e.g., a non-transitory computer-readable storage medium) and the one or more processors operate in conjunction to carry out various functions attributed to AOI unit 140 as described herein. For example, data store 410 may store the one or more modules or components embodied as instructions executable by the one or more processors of controller 405. The instructions, when executed by controller 405, cause controller 405 to carry out the functions attributed to the various modules or applications of controller 405.

AOI unit 140 may be configured to receive device location data 122 from one or more device location data providers 120A-N over a network (e.g., network 130). AOI unit 140 may receive the data 122 on a periodic or an aperiodic basis. For example, AOI unit 140 may receive device location data 122 on a daily or hourly basis. Device location data 122 (e.g., data shown in FIG. 3) received by AOI unit 140 may be stored in a device location data table in data store 410. For example, data store 410 may store the received device location data 122 corresponding to geographic area 205. Device location data 122 stored in data store 410 may also include device location data for other geographic areas and may include all device location data that device location data providers 120 can provide to AOI unit 140, such as data for an entire state or the entire country or the entire world.

Data store 410 may also store geographic data. The geographic data may include coordinate data indicating boundaries of each of a plurality of geographic regions of a geographic area (at one or more levels of granularities), and coordinate data indicating boundaries of the AOI. The geographic data may also include map data (e.g., geolocation data and information) managed by a geographic information system. AOI unit 140 may use geographic data to determine (e.g., for each row or ping of device location data 122 in the device location data table) locations of locations-enabled devices 220 in relation to AOI 202 and in relation to each of the plurality of geographic regions 210. In particular, AOI unit 140 may use the geographic data in data store 410 to determine, for a reported location from a location-enabled device 220, one of a plurality of the geographic regions 210 that includes the reported location within its boundaries. AOI unit 140 may also use the geographic data in data store 410 to determine if a reported location from a location-enabled device 220 is within boundaries indicated by the definition of the AOI 202.

The geographic data stored in data store 410 may also include population data regarding known populations for each of a plurality of geographic regions at different levels of granularity within a geographic area. For example, the population data may include known accurate populations of each of first geographic regions geographic area 205 is subdivided into (e.g., at a finer granularity level). The population data may also include known accurate populations of each of second geographic regions geographic area 205 is subdivided into (e.g., at a coarser granularity level). At least one of the second regions may be larger than at least one of the first regions.

As a practical example, a geographic area (e.g., metropolitan area, state, or country) may be divided into the smallest geographies for which accurate population counts are available. For example, the geographic area may be divided into a plurality of census block groups (e.g., first geographic regions), and the population data may include known accurate population counts for each of the plurality of census block groups. The same geographic area may also be divided in other ways, e.g., by zipcode, neighborhood, metropolitan area, county, state, or other commonly used or custom population blocks (e.g., second geographic regions) so long as accurate (e.g., official) population counts for each such divided region or block is available. Thus, the population data may also include known accurate population counts for (each of) the second geographic region(s). In some embodiments, the population data stored in storage 410 may be updated periodically or aperiodically (e.g., based on new census results, address databases, phone number databases, county title databases, tax records databases, and the like) to ensure accuracy of the data.

The population data may further include known accurate population counts for geographic regions (sub-divisions) of a geographic area at additional levels of granularity. Thus, the population data may include multiple population data sets ranging from a population data set for a smallest geography (e.g., census block group; finer granularity level) with accurate population data available (e.g., from a census) to larger geographies (e.g., metropolitan areas; coarser granularity level). The number of levels of granularity that the geographic area can be sub-divided into (and the corresponding number of population data sets) is not limited to a specific number, so long as accurate population counts are available for each level of granularity.

AOI setting module 420 is configured to received AOI configuration data 400 from, e.g., client device 110, to set a target AOI (e.g., AOI 202). For example, AOI setting module 420 may be configured to receive AOI selection data (e.g., geographic coordinate data indicating boundaries of the AOI) by a user selecting a region on a map (e.g., clicking on an entity (e.g., building) on the map, drawing a polygon on the map, and the like) via a user interface. As another example, AOI setting module 420 may be configured to receive the AOI selection data by a user selecting a particular entity having a specific address (e.g., a store, mall, school campus, airport, metropolitan area, and the like) from a list of entities that are available for selection as an AOI that can be analyzed by AOI analysis and reporting unit 140.

AOI setting module 420 may further be configured to set configuration data corresponding to the received AOI selection. For example, AOI setting module 420 may be configured to set AOI configuration data based on a user input via a user interface. As another example, AOI setting module 420 may be configured to automatically set the AOI configuration data based on the received AOI selection, and further based on data stored in data store 410 that corresponds to the received AOI selection. Examples of the configuration data include a type of the AOI (e.g., retail store, gas station, bank, mall, airport, casino, and the like), dwell time range of the AOI, observation time range of the AOI, and observation frequency. Thus, for example, if a user selects a particular casino located at a particular address on a map as an AOI, AOI setting module 420 may be configured to utilize data stored in data store 410 to automatically identify that the “type” of the selected AOI is “casino”, and the dwell time range for the selected AOI is “2-3 hours”.

In some embodiments, AOI setting module 420 may further be configured to adjust the received AOI selection based on the set configuration data 400. That is, AOI setting module 420 may be configured to identify one or more points of interest (POIs) that are determined to be related to the received AOI selection; and expand the received AOI selection to include the identified one or more POIs. For example, AOI setting module 420 may be configured to identify (e.g., using machine learning techniques) predetermined types of POIs as being related to predetermined types of AOIs. Thus, continuing with the above example, casinos (AOI) may be associated with parking lots (POI), and gas stations (POI) in the data store 410, and thus, if the “type” of the selected AOI is “casino”, the AOI setting module 420 may be configured to identify “gas stations”, and “parking lots” as being the types of POIs that are related to the selected AOI, and further determine, based on the geographic data stored in data store 410, whether any POI of the identified type(s) are within a predetermined distance (e.g., immediately adjacent to, in the same superstructure, and the like) from the selected AOI. Based on the determination, AOI setting module 420 may be configured to automatically expand the received AOI selection to include any POIs that are identified to be within the predetermined distance of the AOI. Thus, if the user selects as an AOI, a particular casino on a map by clicking on a building or structure corresponding to the casino, AOI setting module 420 may be configured to automatically expand the AOI selection to include an adjacent parking lot and an adjacent gas station, and when tracking of the number of people visiting the casino, track the number of people who visit the gas station and the parking lot as well, and output the total number as the normalized foot traffic for the casino.

Continuing with FIG. 4, relying on device location data 122 to estimate a number of users visiting a given AOI presents a sampling problem. For example, since the device location data is anonymized, the demographics of the population that is being sampled in the device location data is unknown, and the number of users who visited the AOI that are not included in the device location data set (e.g., because location tracking is disabled on their devices, they are not carrying their cell phones, they don't use cell phones, etc.) is also unknown. To accurately translate the device location data into the number of users visiting the AOI, AOI analysis and reporting unit 140 includes device home location identification module 430, device penetration rate calculation module 440, and AOI analysis module 450, to perform home location normalization using the device location data.

Device home location identification module 430 is configured to utilize the device location data stored in the device location data table of data store 410 and the geographic data stored in data store 410 to determine home locations (e.g., geographic coordinates) of each of the plurality of location-enabled devices whose device location data is stored in the device location data table. To determine the home location for each device 220, device home location identification module 430 may analyze device ping data (e.g., device location data for multiple rows corresponding to the device) corresponding to a predetermined recent period (e.g., last week, last month, rolling week, rolling month, and the like) to determine a location where the device tends to send the ping data from, at night-time (e.g., during the hours of midnight—6 am). Device home location identification module 430 may thus determine for each device, a location where the device generally spends the most time at night and stores this location information for each device as home location data in data store 410. As used herein, “home location data” need not necessarily correspond to a night-time location of a device. The same technique can be applied by device home location identification module 430 to identify a work location or daytime location by determining a location where the device tends to send the ping data from during daytime (e.g., during the hours of 9 am-5 pm), or any location where the device spends the most time every day and store the identified location as home location data in data store 410.

Further, based on the stored home location data for each device, device home location identification module 430 performs geographic region determination processing to determine for each device, a geographic region (e.g., one of regions 210A-N) where the device's home location is located. For example, if device home location identification module 430 determines based on ping data of last 30 days for device A that device A's home location is Location B, if device home location identification module 430 determines which one of regions 210A-N does Location B falls into. If home location identification module 430 determines that Location B falls within geographic boundaries of geographic region X, device home location identification module 430 determines geographic region X as the home location region for device A and stores this information as home location data for device A in data store 410. By performing the geographic region determination processing, device home location identification module 430 determines for each device, its home location geographic region, and further determines based on this data, for each geographic region, a number of location-enabled devices that have home locations within the geographic region. Device home location identification module 430 stores this information as part of the home location data in data store 410.

In some embodiments, device home location identification module 430 performs the above geographic region determination processing for two or more levels of geographic granularities for which the precise population data is available. As explained previously, a geographic area (e.g., area 205 in FIG. 2) may be subdivided into geographic regions at two or more granularity levels ranging from the smallest geography with accurate population data available to larger geographies. Thus, for example, device home location identification module 430 may perform the processing at a first (finer) granularity level to identify, for each device, a geographic region where the device's home location is located, and further perform processing at a second (coarser) granularity level to identify again, for each device, a geographic region where the device's home location is located, and so on, for each granularity level.

In some embodiments, device home location identification module 430 performs the above processing to identify device home locations, identify corresponding geographic regions at one or more granularity levels, and generate the home location data including data regarding the number of devices having home locations in each geographic region at each granularity level, on a periodic or aperiodic basis. For example, device home location identification module 430 may generate and store the home location data for the plurality of devices every 24 hours. Further, instead of performing the processing for multiple granularity levels and storing the corresponding home location data in advance in data store 410, device home location identification module 430 may perform the processing only for the smallest geography whose accurate population data is available, and perform the processing for other larger geographies on an as needed basis based on a set device penetration rate configuration that dictates the need for home location data generation (and device penetration rate calculation) at a particular (coarser) granularity level.

Device penetration rate calculation module 440 calculates device penetration rates for each of the plurality of geographic regions at the one or more levels of granularity based on the home location data and the population data stored in data store 410. To calculate the device penetration rate for each geographic region at each level of granularity, device penetration rate calculation module 440 may obtain, based on the home location data, the number of devices with home locations within the geographic region and divide that number by the (known) population of that geographic region (based on the population data) to calculate the device penetration rate for the particular geographic region (at the particular level of granularity). Device penetration rate calculation module 440 may repeat this process for each geographic region at the particular level of granularity to generate a set of device penetration rates (e.g., device penetration rate set) for the particular level of geographic granularity. For example, if the (known) population of a particular geographic region is 1000, and the number of devices (determined based on device location data 122) that have home locations in the particular geographic region are 100, device penetration rate calculation module 440 determines that the device penetration rate of the particular geographic region is 100/1000=0.1 (or 10%). Device penetration rate calculation module 440 may store the set of device penetration rates calculated as described above as device penetration rate data in data store 410.

Device penetration rate calculation module 440 may generate a set of (one or more) device penetration rates for additional levels of geographic granularity for which the precise population data is available and store each set as the device penetration rate data in data store 410. Further, device penetration rate calculation module 440 may perform the device penetration rate calculation and generate the device penetration rate data on a periodic or aperiodic basis (e.g., every 24 hours). Still further, instead of performing the processing for multiple granularity levels and storing the corresponding data of the set of device penetration rates in advance in data store 410, module 440 may perform the processing to generate the rate set for the smallest geography for which population data is available, and perform the processing to generate the rate set for other larger geographies on an as needed basis based on a set device penetration rate configuration that dictates which device penetration rate set should be used for the AOI being analyzed.

AOI analysis module 450 counts the number of users in the AOI based on the device penetration rate data generated by device penetration rate calculation module 440 and the data stored in the device location data table in data store 410. AOI analysis module 450 may include counting module 452, and device penetration rate configuration module 454.

Counting module 452 is configured to identify devices out of the plurality of devices corresponding to the device location data whose locations are detected to be within boundaries the AOI. Based on the identification, module 452 generates AOI device location data indicating the number of the devices 220 whose locations are determined to be within the AOI. That is, counting module 452 is configured to utilize the device location data stored in the device location data table of data store 410, and the geographic data stored in data store 410 to determine for each ping of each of the plurality of location-enabled devices, a location (e.g., geographic coordinates) of the device and whether the determined location is within geographic boundaries defined by the set AOI.

Counting module 452 makes the determination for each device based on whether the device location data of the device meets predetermined conditions set in the configuration data 400 corresponding to the AOI. Examples of the predetermined conditions set in the configuration data 400 include an observation time range condition, a dwell time range condition, and the like. For example, to determine for each device, whether the determined location of the device is within geographic boundaries defined by the set AOI, counting module 452 may analyze device ping data (e.g., device location data for multiple pings over time corresponding to the device) corresponding to a predetermined recent period (e.g., current day, current hour, and the like) and determines whether the ping data meets the observation time range condition (e.g., ping indicates user of device visited AOI during predetermined observation time range (e.g., between 9 am-5 pm). As another example, counting module 452 may analyze device the ping data to determine whether the ping data of the device meets the dwell time range condition (e.g., ping data indicates dwell time of user of device at AOI was within the predetermined dwell time range (e.g., between 2-3 hours)). By performing the above processing, counting module 452 determines for the AOI, a number of location-enabled devices that visited the AOI and that met predetermined conditions, and stores this information as the AOI device location data in data store 410.

Device penetration rate configuration module 454 determines or sets a device penetration rate configuration based on one or more characteristics of the AOI (e.g., based on AOI configuration data 400). And the device penetration rate configuration module 454 sets a device penetration rate set (e.g., out of plural device penetration rate sets corresponding to different levels of geographic granularity generated by device penetration rate calculation module 440) to be used for translating the AOI device location data into an accurate count of users visiting the AOI, based on the determined device penetration rate configuration. For example, the one or more characteristics of the AOI may include a type of the AOI (e.g., airport, university, neighborhood, retail store, bank, etc.), an application type (e.g., Application A, Application B) that generated the AOI device location data, an observation frequency set for the AOI (e.g., daily, weekly), a typical visitor dwell time (e.g., a few minutes, a few hours, etc.) for the AOI, an expected number of visitors for the AOI (e.g., a few, a few thousand, etc.) and the like.

Based on the configuration, device penetration rate configuration module 454 may obtain a set of device penetration rates from data store 410 and corresponding to a particular level of geographic granularity, to calculate weighting factors for each device detected to be within the AOI. Alternately, based on the configuration, device penetration rate configuration module 454 may control calculation module 440 to calculate a set of device penetration rates corresponding to a particular level of geographic granularity (or corresponding to filtered device location data to be app-specific) to calculate the weighting factors for each device detected to be within the AOI.

For example, in response to module 454 determining based on the type (e.g., high-end retail store) of the selected AOI that the weighting factors for each device detected to be within the AOI should be calculated based on device penetration rates for finer (or finest) geographic regions whose accurate population data is available, module 454 may select a set of device penetration rates accordingly and provide the device penetration rate set to counting module 452 for calculating the weighting factors for each device detected to be within the AOI. As another example, in response to module 454 determining based on the type (e.g., airport, metropolitan area) of the selected AOI that the weighting factors for each device detected to be within the AOI should be calculated based on (generic; one or more) device penetration rate(s) for coarser or larger geographic region(s), module 454 may select (or calculate) the device penetration rate(s) for the larger geographic region(s) for calculating the weighting factors for each device detected to be within the AOI.

Thus, if the characteristics of the AOI (e.g., AOI type, AOI observation frequency) indicate that demographics of the devices detected within the AOI likely accurately sample demographics of a larger geographic area (e.g., whole city, state, or country) as a whole, instead of individually calculating weighing factors for each device within the AOI based on corresponding device penetration rates in corresponding granular (smaller; finer) geographic regions of the device home locations, a single weighting factor may be used for all AOI devices based on a single device penetration rate calculated corresponding to the whole geographic area where the granular (smaller; finer) geographic regions are located, or two or more weighting factors may be used for the AOI devices based on two or more device penetration rates calculated corresponding to two or more geographic areas where the granular (smaller; finer) geographic regions are located.

Continuing with FIG. 4, counting module 452 counts the number of people visiting the AOI based on the AOI device location data and the calculated device penetration rates. That is, for each device determined by counting module 452 as being within the AOI, counting module 452 calculates a weighting factor for the device based on the device penetration rate in the geographic area of the device's home location. That is, based on the set of device penetration rates selected by the device penetration rate configuration module 454, counting module 452 calculates normalized foot traffic within the AOI by weighing each device within the AOI with the corresponding weighting factor (i.e., inverse of the device penetration rate), and summing the weighted device counts.

As an example, consider a case where two devices ping within a given AOI on a given day (determined based on the device location data). One device is determined by device home location identification module 430 to have a home location in a geographical region A, and the other device is determined by the by device home location identification module 430 to have a home location in geographical region B. Further, device penetration rate configuration module 454 has determined based on the characteristics of the given AOI that penetration rates corresponding to regions A and B are to be used for the calculation. Further, the population data in data store 410 indicates that geographical region A has a population of 1000, and geographical region B has a population of 500. And the home location data generated by device home location identification module 430 indicates that 100 devices have home locations in geographical region A, and that 5 devices have home locations in geographical region B. In this example, device penetration rate calculation module 440 may determine geographical region A to have a device penetration rate of 0.1 (100/1000) and determine geographical region B to have a device penetration rate of 0.01 (5/500). Further, counting module 452 may determine a weighting factor for each device as the inverse of the penetration rate. Thus, the first device will have a weighting factor of 10 (1/0.1), and the second device will have a weighting factor of 100 (1/0.01). And the counting module 452 will count the number of users in the AOI (e.g., normalized foot traffic) as a summation of the weighting factors of the devices (10+100). Thus, the normalized foot traffic for the given AOI in this case would then be 110.

With the home-location based normalization by AOI analysis and reporting unit 140, improved foot traffic prediction can be made for a given AOI, since each device detected within the AOI can be subject to a targeted weighting factor based on the home location of the device and such that a smallest geography whose accurate population counts are available are used in determining the corresponding device penetration rates. As a result, the method corrects for time, geographic, and (indirectly) demographic dependencies for the AOI device location data, and obtains a more accurate foot traffic count for the AOI, since regional differences in demographics of the population are preserved. That is, the method obtains a foot traffic count for the AOI that is more accurate than the raw count and more accurate than an estimate based on a single global device penetration rate.

However, depending on the AOI, it may be desirable to perform the home-location normalization based on larger geographies and corresponding device penetration rates (or based on a single (generic) device penetration rate for the geography corresponding to the device location data as a whole) since it may be likely that demographics of the devices detected within the AOI sample demographics of the larger geography (e.g., whole city, state, or country) as a whole. For example, it may be the case that when measuring normalized foot traffic at a major airport (where people may visit from around the world) the demographics of the (users of the) devices detected within the airport sample demographics of the country or world itself. And in this case, instead of calculating (or looking up from a database) a device penetration rate (and corresponding weighting factor) for each device detected at the airport based on the device's home location (which may be anywhere around the country or world) and the granular region, e.g., census block group, the device's home location falls into, a (generic) device penetration rate corresponding to the whole country or world (e.g., number of devices detected in the whole country divided by known population of the country) may be used for calculating the (generic) weighting factor for each device at the airport, thereby significantly simplifying the normalized foot traffic calculation operation and increasing computational efficiency without significantly degrading accuracy of the foot traffic count (because the AOI devices accurately sample the population of the overall geographic area). The above airport example illustrates where one device penetration rate may be used for all devices in the AOI. In other examples, a few (e.g., two or more) device penetration rates (e.g., a rate for each city, metropolitan area, or state) may be used for calculating the weighting factors for the devices at the airport, while still producing the advantageous effects of significantly simplifying the normalized foot traffic calculation operation and increasing computational efficiency while maintaining accuracy of the foot traffic count, as compared to the case where the smallest geography (e.g., census block group) whose accurate population counts are available is used in determining the device penetration rates and corresponding weighting factors for each device in the AOI.

Counting module 452 may perform the processing to perform the normalized foot traffic calculation for the AOI based on a predetermined observation frequency, as determined based on the AOI configuration data 400. For example, counting module 452 may estimate the number of users visiting the AOI on a daily basis, based on the AOI device location data for that day.

Device filtering module 460 may be configured to perform a filtering operation for each geographic region at each level of granularity when generating the home location data indicating the number of devices in each geographic region for the device penetration rate calculation. Device filtering module 460 may further be configured to filter AOI device location data. For example, when counting for different geographic regions at a given level of geographic granularity (e.g., the smallest geography for which accurate population data is available), the number of devices with home locations in the geographic region, device filtering module 460 may filter the device home location data for the geographic region to remove devices based on different criteria. For example, the criteria may include filtering the devices based on the application generating the device location data so that the home location data for the region corresponds to a specific application (e.g., smartphone app) based on, e.g., application ID 340 in FIG. 3. That is, the home location data for each region may be calculated on an “app-by-app” basis. The calculated device penetration rates may thus take into consideration only the filtered number of devices corresponding to the specific application relative to the respective population counts.

Device filtering module 460 may also filter the AOI device location data for the AOI to remove devices based on different criteria. For example, the criteria may include filtering the devices in the AOI based on the application that generated the device location data so that the AOI device location data corresponds to a specific application (e.g., smartphone app) based on, e.g., application ID 340 in FIG. 3. That is, the AOI device location data may also be generated on an “app-by-app” basis. Any resultant AOI foot traffic count that is based on app-specific home location data, and app-specific AOI device location data may thus more accurately represent the target demographic (e.g., teenagers, senior citizens, etc.) of the specific application because the normalization is applied based on the devices that have similar activity profiles. AOI filtering module 460 may also be configured to apply filters to the AOI device location data based on other criteria like the anticipated dwell time for the selected AOI.

AOI reporting module 470 may report the estimated home-location normalized foot traffic counts to a user. For example, AOI reporting module 470 may report the estimated home-location normalized foot traffic counts via a user interface (e.g., as discussed below with respect to FIG. 8) displayed on client device 110 showing a time chart of daily foot traffic counts. As other example, the normalized foot traffic counts may be reported by AOI reporting module 470 via an API that makes this data available to other applications. AOI reporting module 470 may also report the data by other means, e.g., heat maps, meta data showing contributor determined data, as input for other calculations or uses of the data.

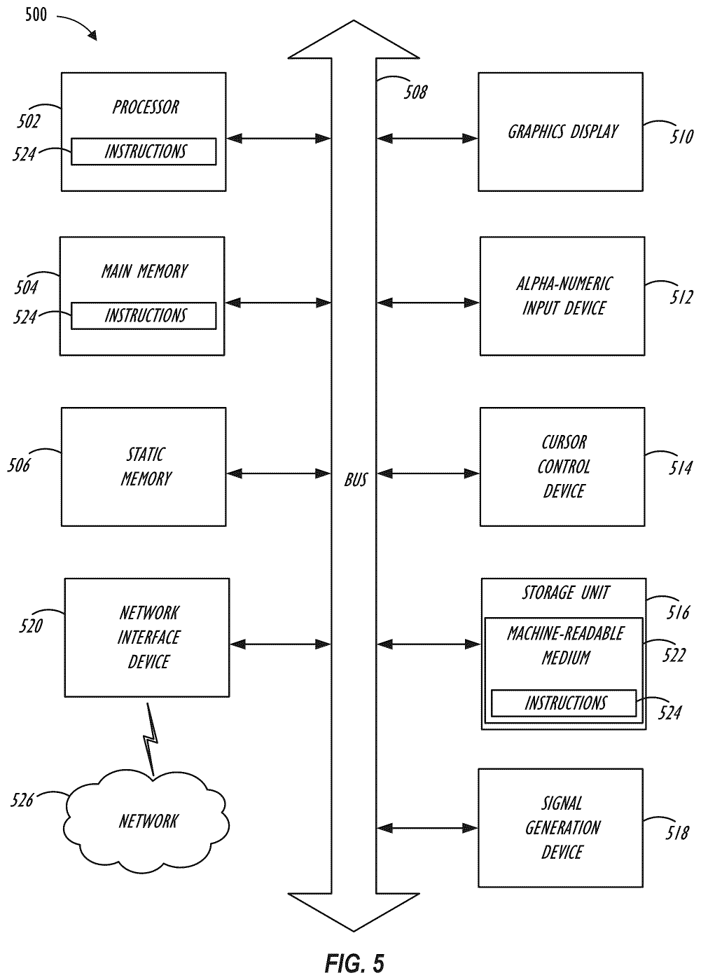

FIG. 5 is a block diagram illustrating components of an example machine able to read instructions from a machine-readable medium and execute them in a processor (or controller). Specifically, FIG. 5 shows a diagrammatic representation of a machine in the example form of a computer system 500 within which program code (e.g., software) for causing the machine to perform any one or more of the methodologies discussed herein may be executed. The program code may be comprised of instructions 524 executable by one or more processors 502. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions 524 (sequential or otherwise) that specify actions to be taken by that machine. Further, while only a single machine is illustrated, the term “machine” shall also be taken to include any collection of machines that individually or jointly execute instructions 524 to perform any one or more of the methodologies discussed herein.

The example computer system 500 includes a processor 502 (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 504, and a static memory 506, which are configured to communicate with each other via a bus 508. The computer system 500 may further include visual display interface 510. The visual interface may include a software driver that enables displaying user interfaces on a screen (or display). The visual interface may display user interfaces directly (e.g., on the screen) or indirectly on a surface, window, or the like (e.g., via a visual projection unit). For ease of discussion the visual interface may be described as a screen. The visual interface 510 may include or may interface with a touch enabled screen. The computer system 500 may also include alphanumeric input device 512 (e.g., a keyboard or touch screen keyboard), a cursor control device 514 (e.g., a mouse, a trackball, a joystick, a motion sensor, or other pointing instrument), a storage unit 516, a signal generation device 518 (e.g., a speaker), and a network interface device 520, which also are configured to communicate via the bus 508.

The storage unit 516 includes a machine-readable medium 522 on which is stored instructions 524 (e.g., software) embodying any one or more of the methodologies or functions described herein. The instructions 524 (e.g., software) may also reside, completely or at least partially, within the main memory 504 or within the processor 502 (e.g., within a processor's cache memory) during execution thereof by the computer system 500, the main memory 504 and the processor 502 also constituting machine-readable media. The instructions 524 (e.g., software) may be transmitted or received over a network 526 via the network interface device 520.

While machine-readable medium 522 is shown in an example embodiment to be a single medium, the term “machine-readable medium” should be taken to include a single medium or multiple media (e.g., a centralized or distributed database, or associated caches and servers) able to store instructions (e.g., instructions 524). The term “machine-readable medium” shall also be taken to include any medium that is capable of storing instructions (e.g., instructions 524) for execution by the machine and that cause the machine to perform any one or more of the methodologies disclosed herein. The term “machine-readable medium” includes, but not be limited to, data repositories in the form of solid-state memories, optical media, and magnetic media.

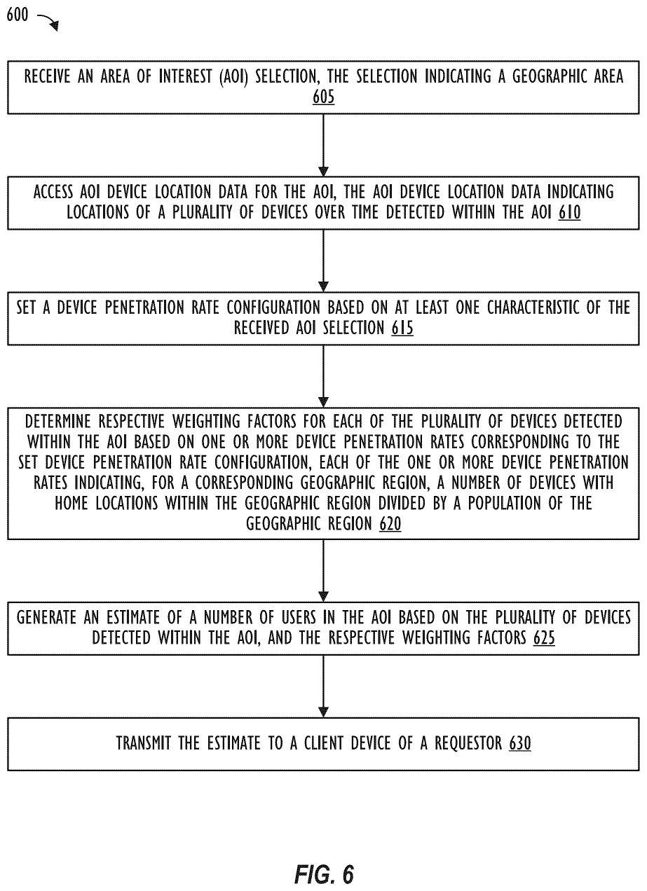

FIG. 6 is an exemplary flowchart of process 600 for estimating foot traffic in an AOI. The elements of process 600 may be performed by processor 502 executing instructions 524. The elements of process 600 are merely exemplary and may be performed in any order or include fewer or additional elements in accordance with the other description within this disclosure. Process 600 begins with AOI analysis and reporting unit 140 receiving 605 an AOI selection (e.g., AOI 202), the selection indicating a geographic area. AOI analysis and reporting unit 140 may then access 610 AOI device location data (e.g., generated by counting module 452 and stored in data store 410) for the AOI, the AOI device location data indicating locations of a plurality of devices (e.g., devices 220) over time detected within the AOI.

Device penetration rate configuration module 454 may then set 615 a device penetration rate configuration based on at least one characteristic (e.g., type of AOI, expected visitor traffic volume for the AOI (e.g., single-digit counts, hundreds of visitors, thousands of visitors, etc.), typical visitor dwell time at the AOI, etc.) of the received AOI selection. Examples of the device penetration rate configuration include a configuration where a geographic area is divided into the smallest possible geographies for which population data is available and device penetration rates are calculated for each divided geographic region based on all devices with home location in the region, a configuration where a geographic area is divided into the smallest possible geographies for which population data is available and device penetration rates are calculated for each divided geographic region based on devices that have home location in the region and that have a specific application installed thereon that sent the device location data thereof, a configuration where a generic device penetration rate is calculated for the geographic area as a whole based on all devices with home location in the geographic area as a whole, a configuration where a generic device penetration rate is calculated for the geographic area as a whole based on devices that have home location in the geographic area as a whole and that have a specific application installed thereon that sent the device location data thereof, a configuration where a geographic area is divided into regions larger than the smallest possible geographies for which population data is available and device penetration rates are calculated for each larger geographic region based on devices that have home location in the larger region, and the like.

At element 620, counting module 452 may determine respective weighting factors (e.g., inverse of the device penetration rates set based on the device penetration rate configuration at element 615) for each of the plurality of devices detected within the AOI based on one or more device penetration rates corresponding to the set device penetration rate configuration, each of the one or more device penetration rates indicating, for a corresponding geographic region (e.g., geographic regions 210A-N in FIG. 2), a number of devices with home locations within the geographic region (e.g., determined by module 430) divided by a population of the geographic region (e.g., stored in data store 410).

Counting module 452 may then generate 625 an estimate of a number of users in the AOI based on the plurality of devices detected within the AOI, and the respective weighting factors, and AOI reporting module 470 may then transmit 625 the estimate to a client device (e.g., device 110 of FIG. 1; as shown in user interface of FIG. 8 described below) of a requestor. In some embodiments, one or more of the steps of process 600 may be performed, e.g., on a daily basis, based on an observation frequency set by a user.

FIG. 7 depicts an exemplary user interface for inputting an AOI and corresponding configuration data. User interface 700 may be displayed on client device 110 and includes AOI selection screen 710 and configuration data input section 720. AOI selection screen 710 shows an interactive map and includes features allowing a user to scroll the map, zoom-in, zoom-out, draw a polygon, select an area on the map, and the like. For example, a user may interact with the map to scroll and zoom-into a desired area and select an AOI. The region on the map selected by the user may be displayed conspicuously (730) to indicate to the user that the region has been selected as an AOI. Configuration data input section 720 may include data that may be automatically populated by AOI setting module 420 based on the selected AOI 730. For example, AOI setting module 420 may auto populate an AOI name, a size of the AOI, an observation time range, a dwell time range, and the like. The configuration data input section 720 may also allow the user to enter additional data and/or update any of the auto populated data and save the AOI as an AOI project for analysis and reporting by AOI analysis and reporting unit 140.

FIG. 8 depicts an exemplary user interface for receiving normalized foot traffic data as an output based on the input AOI configuration data and corresponding AOI device location data. User interface 800 may also be displayed on client device 110 and includes output screen 810 showing data reported by AOI reporting module 470. In the example user interface shown in FIG. 8, output screen 810 shows a time chart indicating the number of users that have visited the selected AOI (730) on a daily basis between specific start and end dates and/or times input by the user. By visualizing the data on a time chart, output screen 810 enables the user to spot spike or depletion data anomalies and trends that become evident from the data. With the home-location based normalization technique of the present disclosure, since weighting factors of devices are based on the known population counts of the regions where the device home locations are located, accuracy of the foot traffic estimates is maintained even if devices belonging to certain demographics disproportionately opt out of location tracking. For example, college students may disproportionately opt out of location tracking and drop out of the home location data set, and the anonymized device location data received from the data aggregators may not provide this information to the AOI analysis and reporting unit. However, since the remaining devices with home locations in geographic regions with a lot of college students (and thus likely to be associated with college students) will receive greater weight (i.e., larger weighting factors for each device from that region) when estimating foot traffic, the home-location based normalization technique of the present disclosure compensates for the time-varying, demographic-dependent shift in the device location data, thereby maintaining accuracy of the foot traffic estimates.

### Additional Configuration Considerations

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for using machine learning to generate a capability map through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method comprising:
receiving an area of interest (AOI) selection, the selection indicating a geographic area;
accessing AOI device location data for the AOI, the AOI device location data indicating locations of a plurality of devices detected within the AOI;
setting a device penetration rate configuration based on at least one characteristic of the received AOI selection;
determining respective weighting factors for each of the plurality of devices detected within the AOI based on one or more device penetration rates corresponding to the set device penetration rate configuration, each of the one or more device penetration rates indicating, for a corresponding geographic region, a number of devices with home locations within the geographic region divided by a population of the geographic region;
generating an estimate of a number of users in the AOI based on the plurality of devices detected within the AOI, and the respective weighting factors; and
transmitting the estimate to a client device of a requestor.

2. The method of claim 1, wherein the at least one characteristic of the received AOI selection comprises at least one of a determined type of the AOI, an application type corresponding to the AOI device location data, and an observation frequency of the AOI.

3. The method of claim 1, wherein the device penetration rate configuration is set as one of: (i) a first configuration in which respective device penetration rates are determined for a plurality of first geographic regions, and (ii) a second configuration in which at least a second device penetration rate is determined for at least a second geographic region.

4. The method of claim 3, wherein the device penetration rate configuration is set as the first configuration, and
wherein determining the respective weighting factors for each of the plurality of devices comprises:
accessing device home location data for each of the plurality of first geographic regions, wherein the device home location data for each of the plurality of first geographic regions indicates a number of devices detected to have home locations within the region; and
generating, as the one or more device penetration rates, respective device penetration rates for each of the plurality of first geographic regions based on the device home location data for the region, and regional population data corresponding to the region;
wherein for a given device detected within the AOI, a corresponding determined weighting factor is inversely proportional to the device penetration rate of the region corresponding to the home location of the given device.

5. The method of claim 4, further comprising filtering the device home location data for each of the plurality of first geographic regions based on the at least one criteria, wherein the respective device penetration rates for each of the plurality of first geographic regions are generated based on the filtered device home location data.

6. The method of claim 3, wherein the plurality of first geographic regions respectively correspond to one of: (i) a plurality of census blocks; (ii) a plurality of census block groups; and (iii) a plurality of census tracts.

7. The method of claim 3, wherein the device penetration rate configuration is set as the second configuration, and
wherein determining the respective weighting factors for each of the plurality of devices comprises:
accessing device home location data for the second geographic region, wherein the device home location data for the second geographic region indicates a number of devices detected to have home locations within the region; and
generating as the one or more device penetration rates, a generic device penetration rate for the second geographic region based on the device home location data for the region, and regional population data corresponding to the region;
wherein for each of the plurality of devices detected within the AOI, a corresponding determined weighting factor is inversely proportional to the generic device penetration rate.

8. The method of claim 7, further comprising filtering the device home location data for the second geographic region based on the at least one criteria,
wherein the generic device penetration rate for the second geographic region is generated based on the filtered device home location data.

9. The method of claim 3, wherein the second geographic region is larger than each of the plurality of first geographic regions.

10. The method of claim 9, wherein the second geographic region is equal to the plurality of first geographic regions combined.

11. The method of claim 1, further comprising:
receiving a dwell time range selection; and
filtering the AOI device location data by identifying devices from among the plurality of devices that fall outside the received dwell time range selection.

12. The method of claim 1, further comprising:
determining a type of the received AOI selection;
referencing a data structure that maps AOI types with dwell times to identify a dwell time corresponding to the determined type of the received AOI selection;
setting a time range based on the identified dwell time; and
filtering the AOI device location data by identifying devices from among the plurality of devices that fall outside the set time range.

13. The method of claim 1, further comprising:
identifying one or more points of interest (POIs) that are determined to be related to the received AOI selection; and
expanding the received AOI selection to include the identified one or more POIs;
wherein the AOI device location data includes data indicating locations of a plurality of devices detected within the AOI expanded to include the one or more POIs.

14. A non-transitory computer-readable medium comprising memory with instructions encoded thereon, the instructions, when executed by one or more processors, causing the one or more processors to perform operations, the instructions comprising instructions to:
receive an area of interest (AOI) selection, the selection indicating a geographic area;
access AOI device location data for the AOI, the AOI device location data indicating locations of a plurality of devices detected within the AOI;
set a device penetration rate configuration based on at least one characteristic of the received AOI selection;
determine respective weighting factors for each of the plurality of devices detected within the AOI based on one or more device penetration rates corresponding to the set device penetration rate configuration, each of the one or more device penetration rates indicating, for a corresponding geographic region, a number of devices with home locations within the geographic region divided by a population of the geographic region;
generate an estimate of a number of users in the AOI based on the plurality of devices detected within the AOI, and the respective weighting factors; and
transmit the estimate to a client device of a requestor.

15. The non-transitory computer-readable medium of claim 14, wherein the at least one characteristic of the received AOI selection comprises at least one of a determined type of the AOI, an application type corresponding to the AOI device location data, and an observation frequency of the AOI.

16. The non-transitory computer-readable medium of claim 14, wherein the device penetration rate configuration is set as one of: (i) a first configuration in which respective device penetration rates are determined for a plurality of first geographic regions, and (ii) a second configuration in which at least a second device penetration rate is determined for at least a second geographic region.

17. The non-transitory computer-readable medium of claim 16, wherein the device penetration rate configuration is set as the first configuration, and
wherein the instructions to determine the respective weighting factors for each of the plurality of devices comprise instructions to:
access device home location data for each of the plurality of first geographic regions, wherein the device home location data for each of the plurality of first geographic regions indicates a number of devices detected to have home locations within the region; and
generate as the one or more device penetration rates, respective device penetration rates for each of the plurality of first geographic regions based on the device home location data for the region, and regional population data corresponding to the region;
wherein for a given device detected within the AOI, a corresponding determined weighting factor is inversely proportional to the device penetration rate of the region corresponding to the home location of the given device.

18. The non-transitory computer-readable medium of claim 16, wherein the device penetration rate configuration is set as the second configuration, and
wherein the instructions to determine the respective weighting factors for each of the plurality of devices comprise instructions to:
accessing device home location data for the second geographic region, wherein the device home location data for the second geographic region indicates a number of devices detected to have home locations within the region; and
generating as the one or more device penetration rates, a generic device penetration rate for the second geographic region based on the device home location data for the region, and regional population data corresponding to the region;
wherein for each of the plurality of devices detected within the AOI, a corresponding determined weighting factor is inversely proportional to the generic device penetration rate.

19. The non-transitory computer-readable medium of claim 18, wherein the second geographic region is larger than each of the plurality of first geographic regions.

20. A system comprising:
memory with instructions encoded thereon; and
one or more processors that, when executing the instructions, are caused to perform operations comprising:
receiving an area of interest (AOI) selection, the selection indicating a geographic area;
accessing AOI device location data for the AOI, the AOI device location data indicating locations of a plurality of devices detected within the AOI;
setting a device penetration rate configuration based on at least one characteristic of the received AOI selection;
determining respective weighting factors for each of the plurality of devices detected within the AOI based on one or more device penetration rates corresponding to the set device penetration rate configuration, each of the one or more device penetration rates indicating, for a corresponding geographic region, a number of devices with home locations within the geographic region divided by a population of the geographic region;
generating an estimate of a number of users in the AOI based on the plurality of devices detected within the AOI, and the respective weighting factors; and
transmitting the estimate to a client device of a requestor.
